(19) United States
(12) Patent Application Publication
(10) Pub. No.: US 2006/0239176 A1
(43) Pub. Date: Oct. 26, 2006

(54) Method and apparatus for processing a return path signal

(76) Inventors: William J. Garrison, Warminster, PA (US); Clive E. Holborow, San Diego, CA (US); Gerard White, Dunstable, MA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/112,959

(22) Filed: Apr. 22, 2005

(51) Int. Cl. H04J 9/00; H04J 1/00; H04L 5/04

(52) U.S. Cl. 370/204; 370/480

(57) ABSTRACT

A method and apparatus for processing a return path signal transmitted from a user device is described. In one example, an apparatus receives, and subsequently decodes, a return path signal that is transmitted from a user device. From the decoded signal, the type of user device transmitting the return path signal is determined. The apparatus then routes the return path signal to a media access control (MAC) processor that is specifically designed to process return path signals transmitted from the determined type of user device.

### BACKGROUND OF THE INVENTION

1. Field of the Invention

Embodiments of the present invention generally relate to information transmission networks, and more particularly, to a method and apparatus for processing a return path signal transmitted from a user device.

2. Description of the Related Art

Traditionally, a broadband network entails a plurality of service (e.g., voice, data, video, etc.) providers supplying data to a headend facility, which distributes the data to a plurality of service locations (e.g., residences). The type of data distributed to the service locations is dependent on the signal provided by bridging devices to the service provider's network for the respective service locations. Although these bridging devices enable the corresponding service locations to receive and transmit transmission signals to the headend, these devices are not without their disadvantages.

Currently, the bridging devices are manufactured with a single demodulator designed to only support the transmission of one type of return path protocol over a digital network from a set top box or cable modem. In order to process a plurality of return path protocols with the present art, a separate bridging device is needed for individually processing each unique return path protocol. Thus, since the relevant art is presently limited to support only one return path protocol, the types of set top boxes and cable modems that this bridging device can support is similarly restricted.

Therefore, there is a need in the art for a single apparatus and method for processing return path signals transmitted by a plurality of different types of user devices (e.g., set top boxes, cable modems, Voice over IP gateways, etc).

### SUMMARY OF THE INVENTION

The invention provides a method and apparatus for processing a return path signal transmitted from a user device. In one embodiment, the invention receives, and subsequently decodes, a return path signal that is transmitted from a user device. From the decoded signal, the type of user device transmitting the return path signal is determined. The invention then routes the return path signal to a media access control (MAC) processor that is specifically designed to process return path signals transmitted from the determined type of user device.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of a general embodiment of a network system employing the principles of the present invention;

FIG. 2 depicts a block diagram of one embodiment of a bridging device capable of processing a return path signal in accordance with the present invention; and

FIG. 3 is a flow diagram of a method for processing a return path signal transmitted from a user device in accordance with the present invention.

### DETAILED DESCRIPTION

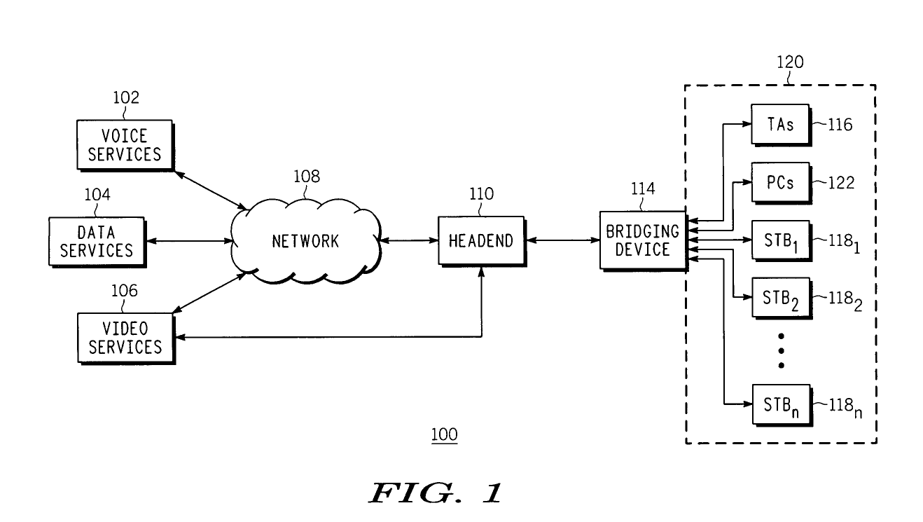

FIG. 1 depicts a network system 100 (e.g., a passive optical network) in which the embodiments of the present invention may be utilized. This figure only portrays one variation of the myriad of possible system configurations. For example, FIG. 1 could have depicted several headends 110, numerous service locations 120, and a plurality of corresponding bridging devices 114. For simplicity and clarity, only one headend 110, service location 120, and bridging device 114 are depicted and described. The invention, as shall be discussed below, is a method and apparatus for processing a return path signal transmitted from a user device, such as a conventional set top box.

The network 100 comprises at least one service location 120 that is supported by an associated bridging device 114. The bridging device 114 is coupled to a headend 110. In one embodiment, the headend 110 is connected to a voice services provider 102 and data services provider 104 through a communication network 108 (e.g., the Internet). Similarly, the headend 110 may be coupled to video services provider 106 either through a direct connection and/or via the communication network 108.

The service location 120 is typically a residence, but may be any area or building that is supported by a bridging device 114. The service location 120 typically contains a plurality of devices such as, but not limited to, telephony adapters 116, personal computers (PCs) 122, and set top boxes 118_{1 . . . n}. Although only one telephony adapter 116 and PC 122 are shown for the sake of clarity, additional telephony adapters or PCs may be supported by the bridging device 114. Similarly, the service location 120 may contain a plurality of set top boxes 118_{1 . . . n}.

The set top box 118 may be an end-user or cable service subscriber tuner/demultiplexer/decoder and embedded system. For example, one embodiment of the set top box 118 may be an apparatus similar to the Motorola DCT2500 or the Scientific-Atlanta EXPLORER 8000. The set top box 118 is typically connected to the cable operator RF feed and drives the subscriber's display unit or television set (not shown). The video segments may be received via a packet stream (e.g. MPEG Transport Stream or video-over-IP) or as analog video.

The headend 110 may be any physical site where modulation, demodulation, and processing (controlling, monitoring, etc.) equipment is kept and operated. The headend 110 typically comprises a master facility that receives television signals for processing and distributing over the network system 100. In one embodiment, the headend 110 is a building or large structure that contains electronic equipment used to receive and re-transmit video over the network system 100.

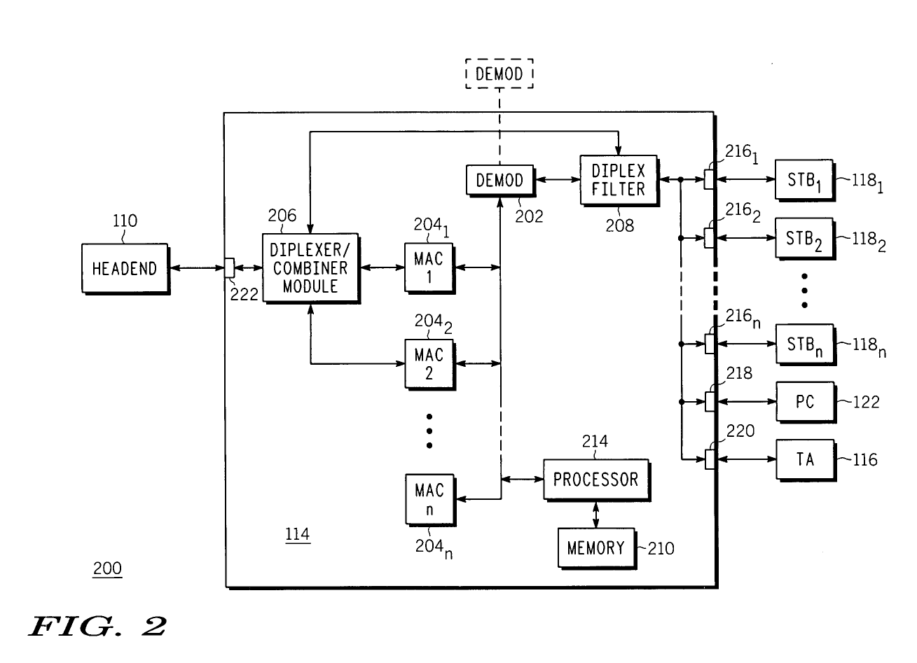

FIG. 2 depicts a block diagram of one embodiment of the bridging device 114, which may have an upstream port 222 and multiple device ports 216_{1 . . . n}, 218, 220. The upstream port 222 enables the bridging device 114 to communicate with the headend 110 via twisted pair wiring, optical fiber, coaxial cable or a hybrid system made up of a combination of coaxial cable and optical fiber. The plurality of device ports 216_{1 . . . n}, 218, 220 allows multiple set top boxes 118_{1 . . . n}, telephony adapters 116, PCs 122 and the like, to be connected to and communicate with the bridging device 114.

The bridging device 114 comprises, but is not limited to one or more of the following devices; a diplex filter 208, a processor 214, memory 210, a demodulator 202, a plurality of media access control (MAC) processors 204_{1 . . . n}, and a diplexer/combiner module 206. The diplex filter 208 forwards the signals transmitted from the set top boxes 118_{1 . . . n} to the demodulator 202. Similarly, the diplex filter 208 also receives signals originating from the headend 110. The diplexer/combiner module 206 is utilized to separate upstream (towards the headend) and downstream (away from the headend) signals and combine the upstream signals. The signals that are split and combined might be either optical or RF signals. The demodulator 202 is a device that serves as a common interface for the network device return path utilized by the plurality of telephony adapters, PCs, and the like. The processor 214 may be any conventionally available microprocessor. The memory 210 may comprise flash memory, random access memory (RAM), read only memory (ROM), and the like. The bridging device 114 may be situated in a number of locations depending on the particular embodiment. For example, the bridging device 114 may be located on the side of a service location 120 or building structure (e.g., PON system), positioned on a pole that is located between the service location 120 and the headend 110 (e.g., HFC cable system), or located within the headend 110 itself.

The demodulator 202 is a Physical Layer (PHY) processing module utilized to recover data content from the carrier wave of a received return path signal. The demodulator 202 may support multiple modulation modes (Frequency Shift Keying (FSK), Binary Phase Shift Keying (BPSK), Synchronous Code Division Multiple Access (S-CDMA), Quadrature Phase-Shift Keying (QPSK), Quadrature Amplitude Modulation (QAM), etc.) and multiple data rates (256 kbps, 1.5 Mbps, etc.). The demodulator 202 may also support multiple PHY burst structures (e.g., signal bursts), since the PHY burst structure will vary for each of the MAC processors 204_{1 . . . n}.

In one embodiment, the demodulator 202 is a software defined radio (SDR) module, which employs various signal processing techniques to ascertain when a set top box transmission occurs and determine the format/protocol of the return path signal. The SDR can be described as a radio communication system that utilizes software for the modulation and demodulation of received return path signals. Essentially, an SDR is a radio that can receive and transmit a unique form of radio protocol by executing software based processes. In one embodiment, the SDR receives return path transmissions and monitors the signal for a unique word or indicator sent at the beginning of a burst. This indicator enables the SDR to identify the particular return path protocol from which the signal originated. Thus, the SDR enables the bridging device 114 to support multiple protocols such as, but not limited to, ALOHA (e.g. SCTE 55-1), DOCSIS, and DAVIC (e.g. SCTE 55-2) return paths. In one embodiment, the indicator may be a pattern of transmitted data. In another embodiment, the demodulator 202 may be independent from and positioned outside of the bridging device 114 as illustrated in FIG. 2.

The media access control (MAC) processors 204_{1 . . . n} are responsible for receiving the return path signal from the SDR. After obtaining a signal, a MAC processor 204 processes the bit stream signal so that the data may be comprehended by a receiver at the headend 110. In one embodiment, there is a specific MAC processor 204_{1 . . . n} for each possible type of set top box 118_{1 . . . n}, PC 122 and telephony adapter 116 existing in the service location 120 supported by the associated bridging device 114. The existence of multiple MAC processors 204_{1 . . . n} also provides for the potential of supporting multiple protocols simultaneously. Depending on the embodiment, the MAC processor 204 may be embodied as a field programmable gate-array (FPGA), an applied specific integrated circuit (ASIC) chip, a software process, or the like.

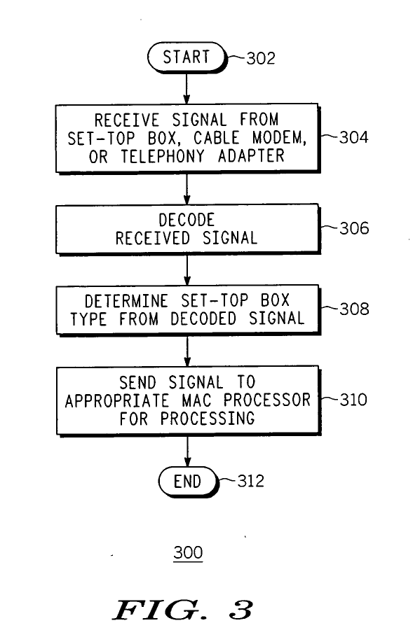

FIG. 3 depicts a flow diagram of a method 300 executed by one embodiment of the present invention. The method 300 commences at step 302 and proceeds to step 304, where a return path signal from a particular set-top box 118, cable modem, telephony adapter 116, or similar device is received. As depicted in FIG. 1, there may be a plurality of set top boxes 118_{1 . . . n} existing at a particular location serviced by the bridging device 114. Notably, each of these set top boxes 118_{1 . . . n} may be of a different type (e.g., a MOTOROLA or SCIENTIFIC-ATLANTA set top box). Each of these different set top boxes 118_{1 . . . n} produces a return path signal that is unique to the specific protocol used by that set top box type. Typically, a set top box 118 receives an instruction, such as a channel select command, and subsequently encodes and transmits the instruction to the bridging device 114.

At step 306, the transmission signal received from the set top box 118 is decoded by the demodulator 202 in the bridging device 114. The bridging device 114 is responsible for interpreting the return path signal so that the encoded command may ultimately be transmitted upstream to the headend 110 in a format acceptable for transmission (e.g., IP or Ethernet format). At step 308, the bridging device 114 determines the PHY burst structure (unique words or other indicators) in the transmission from the set top box 118, PC 122, or telephony adapter 116 in the decoded transmission signal. In one embodiment, a software defined radio (SDR) in the bridging device 114 determines the type of transmission signal received. Essentially, the SDR monitors the return path signal for unique words or indicators that would distinguish one set top box from another. At step 310, the transmission signal is then routed by the demodulator 202 (i.e., the software defined radio in one embodiment) to an appropriate MAC processor 204. More specifically, each MAC processor is specifically designed to process the return path signals transmitted from a particular type of set top box 118, PC 122, or telephony adapter 116. The method 300 then continues to step 312 and ends.

In one embodiment of the present invention, the demodulator 202 (e.g. SDR) exists in the bridging device 114 as described above. However, in an attempt to reduce costs, the MAC processors may be positioned at the headend 110 facility. Thus, in this embodiment, PHY layer processing and MAC layer processing are not required to be conducted at the same location.

It should be noted that the present invention may be implemented in software and/or in a combination of software and hardware, e.g., using the bridging device 114, application specific integrated circuits (ASIC), or any other hardware equivalents. In one embodiment, a software process (e.g., MAC processor) can be utilized with or loaded into memory 210 and executed by processor 214 to implement the functions as discussed above. As such, the present software process (including associated data structures) of the present invention can be stored on a computer readable medium or carrier, e.g., flash memory, random access memory (RAM), and the like.

While the foregoing is directed to embodiments of the present invention, other and further embodiments of the invention may be devised without departing from the basic scope thereof, and the scope thereof is determined by the claims that follow.

What is claimed is:

1. A method for processing a return path signal transmitted from a user device, comprising:
receiving said return path signal at a demodulator;
decoding said return path signal;
determining a particular type of said user device transmitting said return path signal; and
routing said return path signal to a pertinent media access control (MAC) processor belonging to a plurality of MAC processors, wherein said pertinent MAC processor is designed to process said return path signal transmitted from said particular type of said user device.

2. The method of claim 1, wherein said user device comprises at least one of: a set top box, a telephony adapter and a cable modem.

3. The method of claim 1, wherein protocol of said return path signal is at least one of: ALOHA, DOCSIS, and DAVIC.

4. The method of claim 1, wherein said demodulator supports multiple modulation modes.

5. The method of claim 4, wherein said multiple modulation modes include at least one of: Frequency Shift Keying (FSK), Binary Phase Shift Keying (BPSK), Synchronous Code Division Multiple Access (S-CDMA), Quadrature Phase-Shift Keying (QPSK), and Quadrature Amplitude Modulation (QAM).

6. The method of claim 1, wherein said demodulator is a software defined radio.

7. The method of claim 1, wherein said demodulator supports multiple PHY burst structures.

8. The method of claim 1, wherein said demodulator and said MAC processor are located in separate devices.

9. The method of claim 1, wherein said determining step further comprises monitoring for a unique word contained in said return path signal.

10. The method of claim 1, wherein said MAC processor comprises a software process.

11. An apparatus for processing a plurality of return path signals transmitted from a plurality of user devices, comprising:
a plurality of media access control (MAC) processors, wherein each of said plurality of MAC processors is uniquely configured to process one of said plurality of return path signals; and
a demodulator coupled to said plurality of MAC processors for receiving said plurality of return path signals, for decoding said plurality of return path signals, for determining a type of return path signal from said plurality of user devices, and for routing said return path signal to an appropriate MAC processor from said plurality of MAC processors.

12. The apparatus of claim 11, wherein said plurality of user devices comprises at least one of: a set top box, a telephony adapter, and a cable modem.

13. The apparatus of claim 11, wherein protocol of each of said plurality of return path signals is at least one of: ALOHA, DOCSIS, and DAVIC.

14. The apparatus of claim 11, wherein said demodulator supports multiple modulation modes.

15. The apparatus of claim 14, wherein said multiple modulation modes include at least one of: Frequency Shift Keying (FSK), Binary Phase Shift Keying (BPSK), Synchronous Code Division Multiple Access (S-CDMA), Quadrature Phase-Shift Keying (QPSK) and Quadrature Amplitude Modulation (QAM).

16. The apparatus of claim 11, wherein said demodulator is a software defined radio.

17. The apparatus of claim 11, wherein said demodulator supports multiple Physical Layer (PHY) burst structures.

18. The apparatus of claim 11, wherein said demodulator and said plurality of MAC processors are located in different devices.

19. The apparatus of claim 11, wherein said demodulator detects a unique indicator contained in each of said decoded plurality of return path signals and uses said unique indicator to identify a type of user device and select said appropriate MAC processor.

20. A computer readable carrier having stored thereon instructions that, when executed by a processor, causing the processor to perform a method for processing a return path signal transmitted from a user device, comprising:
receiving said return path signal at a demodulator;
decoding said return path signal;
determining a particular type of said user device transmitting said return path signal; and
routing said return path signal to a pertinent media access control (MAC) processor belonging to a plurality of MAC processors, wherein said pertinent MAC processor is designed to process said return path signal transmitted from said particular type of said user device.
